(19) United States
(12) Patent Application Publication
(10) Pub. No.: US 2025/0269752 A1
(43) Pub. Date: Aug. 28, 2025

(54) SYSTEMS AND METHODS FOR AN AGRICULTURAL VEHICLE

(71) Applicant: CNH Industrial America LLC, New Holland, PA (US)

(72) Inventor: Jamil Farhat, Spicer, MN (US)

(21) Appl. No.: 19/063,772

(22) Filed: Feb. 26, 2025

Related U.S. Application Data
(60) Provisional application No. 63/558,343, filed on Feb. 27, 2024.

(51) Int. Cl. B60L 53/62; A01C 23/00; A01M 7/00; B60L 53/12; B60L 53/14; B60L 53/50; B60L 53/53; B60L 53/57; B60L 53/65

(52) U.S. Cl. CPC B60L 53/62; B60L 53/12; B60L 53/14; B60L 53/50; B60L 53/53; B60L 53/57; A01C 23/00; A01M 7/00; B60L 53/65; B60L 2200/10

(57) ABSTRACT

A system for an agricultural operation can include an aerial vehicle configured to apply an agricultural product to a defined location within a field. A base station can include a docking station. The base station can further include a power source station configured to store independently identifiable batteries, a power exchange device configured to install one of the independently identifiable batteries within the aerial vehicle, a power transfer device configured to transfer the one of the independently identifiable batteries to the power exchange device, and a control unit. The control unit can be configured to identify each of the independently identifiable batteries and provide power to one or more of the independently identifiable batteries stored within the power source station.

### CROSS-REFERENCE TO RELATED APPLICATION

This application claims priority to U.S. Provisional Patent Application No. 63/558,343, entitled “SYSTEMS AND METHODS FOR AN AGRICULTURAL VEHICLE,” filed on Feb. 27, 2024. The entire contents of the above-referenced applications are hereby incorporated by reference in their entirety for all purposes.

### FIELD

The present disclosure generally relates to agricultural applicators for performing operations within a field and, more particularly, to systems and methods for performing spraying operations with an agricultural sprayer.

### BACKGROUND

Agricultural sprayers apply an agricultural product (e.g., an herbicide, fertilizer, fungicide, a pesticide, or another product) onto crops and/or a ground surface as the sprayer is traveling proximate to a field. In some instances, the sprayer can support one or more nozzle assemblies. Each nozzle assembly has a valve configured to control the spraying of the agricultural product through a nozzle onto underlying targets, which may include crops, weeds, a ground surface, and/or any other object.

In some instances, the agricultural sprayer may be an unmanned aerial vehicle (UAV). For example, UAV(s) may be flown across a field to apply the agricultural product to the targets. In such instances, an improved system and method for performing spraying operations with the UAV would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system that includes an aerial vehicle configured to apply an agricultural product to a defined location within a field. A base station includes a docking station. The base station also includes a power source station configured to store independently identifiable batteries, a power exchange device configured to install one of the independently identifiable batteries within the aerial vehicle, a power transfer device configured to transfer the one of the independently identifiable batteries to the power exchange device, and a control unit. The control unit is configured to identify each of the independently identifiable batteries and provide power to one or more of the independently identifiable batteries stored within the power source station.

In some aspects, the present subject matter is directed to a method for an agricultural operation. The method includes receiving, from a computing system, instructions to transfer an independently identifiable battery for an aerial vehicle from a power source station to a power exchange device. The method also includes determining, with a control unit, a state of charge of the independently identifiable battery. Lastly, the method includes transferring, with a power transfer assembly, the independently identifiable battery from the power source station to the power exchange device based at least in part on the state of charge of the independently identifiable battery.

In some aspects, the present subject matter is directed to an agricultural system that includes an aerial vehicle configured to apply an agricultural product to a defined location within a field. A base station includes a docking station. The base station further includes a power source station configured to store independently identifiable batteries and a power exchange device configured to install one of the independently identifiable batteries within the aerial vehicle. A power transfer device is configured to transfer the one of the independently identifiable batteries to the power exchange device.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic diagram of a system for an agricultural operation in accordance with aspects of the present subject matter;

FIG. 2 illustrates a schematic diagram of the system for an agricultural operation in accordance with aspects of the present subject matter;

FIG. 3A illustrates a top perspective view of a docking station in accordance with aspects of the present subject matter;

FIG. 3B illustrates a top perspective view of the docking station with an unmanned aerial vehicle (UAV) positioned on the docking station in accordance with aspects of the present subject matter;

FIG. 3C illustrates a top perspective view of the docking station with an unmanned aerial vehicle (UAV) positioned on the docking station in accordance with aspects of the present subject matter;

FIG. 3D illustrates a top perspective view of the docking station with an unmanned aerial vehicle (UAV) positioned on the docking station in accordance with aspects of the present subject matter;

FIG. 4A illustrates a front perspective view of a base station of the system in accordance with various aspects of the present disclosure;

FIG. 4B illustrates an enhanced view of area IVB of FIG. 4A;

FIG. 4C illustrates an enhanced view of area IVC of FIG. 4A;

FIG. 5 illustrates a schematic diagram of various components that may be within the base station in accordance with various aspects of the present disclosure; and

FIG. 6 illustrates a flow diagram of a method for an agricultural operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used throughout this disclosure, the term “autonomous” refers to a vehicle capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or driver input). As such an autonomous vehicle includes those that can operate under operator control during certain time periods and without operator control during other time periods while a semi-autonomous vehicle includes those that can operate under operator control during certain time periods and assist with operator control during other time periods.

As used herein, an unmanned aerial vehicle (UAV) may be any vehicle capable of being flown over a defined area. The UAV may be operated manually from a remote location, capable of autonomous operation, and/or capable of semi-autonomous operation at various times. Moreover, the UAV may be human-controlled, autonomously controlled, and/or semi-autonomously controlled without departing from the teachings provided herein.

In general, the present subject matter is directed to an agricultural system that can include an aerial vehicle, and/or a swarm of aerial vehicles, configured to apply an agricultural product to a defined location within a field.

The system can include a base station that may be utilized in conjunction with the aerial vehicles. In some instances, the base station can include a docking station. The base station can further include a power source station configured to store independently identifiable batteries, a power exchange device configured to install one of the independently identifiable batteries within the aerial vehicle, a power transfer device configured to transfer the one of the independently identifiable batteries to the power exchange device, and a control unit. The control unit can be configured to identify each of the independently identifiable batteries and provide power to one or more of the independently identifiable batteries stored within the power source station.

By storing additional batteries for usage by the aerial vehicles, some batteries may be charged while others are used to power the aerial vehicles. Such a system may allow for the aerial vehicles to operate for longer periods of times, with shorter downtimes. As such, an application operation may be performed in a decreased amount of time.

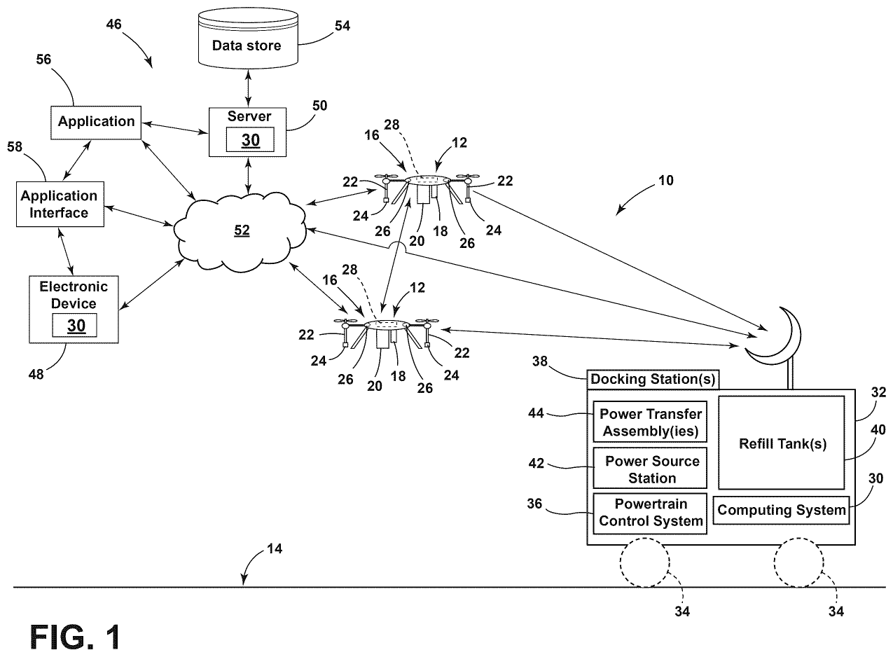

Referring now to FIG. 1, a system 10 for an agricultural operation is illustrated in accordance with aspects of the present subject matter. As shown in FIG. 1, the system may generally include one or more unmanned aerial vehicles (UAV(s)) 12 configured to be flown over a field 14 to perform one or more operations. For instance, the UAV(s) 12 may be configured to dispense an agricultural product (e.g., an herbicide, fertilizer, fungicide, pesticide, or another product) onto the underlying field 14, collect data associated with one or more objects within the field 14, collect data associated with a topology for the field 14, and/or perform any other operation.

Each UAV 12 can include a propulsion system 16 that generates movement of the UAV 12. The propulsion system 16 may be powered by a power source, such as a battery 18, that is operably coupled with the UAV 12. As such, the propulsion system 16 of the UAV 12 may allow the UAV 12 to perform controlled vertical, or nearly vertical, takeoffs and landings. For instance, in the illustrated embodiment, each of the UAV(s) 12 corresponds to a hexacopter in which the propulsion system 16 powers each of four rotors to maneuver the vehicle. However, in other embodiments, one or more of the UAV(s) 12 may correspond to any other multi-rotor aerial vehicle, such as a tricopter, quadcopter, or octocopter. In still further embodiments, one or more of the UAV(s) 12 may be a single-rotor helicopter, or a fixed-wing, hybrid vertical takeoff, and landing aircraft. Still further, it will be appreciated that the UAV(s) 12 may be implemented as any other manned or unmanned vehicle, or combination of types of vehicles, capable of performing any of the functions described herein through operator input, semi-autonomously, and/or autonomously without departing from the scope of the present disclosure.

Each of the UAV(s) 12 may also include an applicator tank(s) 20. The applicator tank(s) 20 is generally configured to store or hold an agricultural product, such as an herbicide, fertilizer, fungicide, pesticide, or another product. The agricultural product is conveyed from the applicator tank(s) 20 through a product circuit including plumbing component(s) 22, such as interconnected pieces of tubing, for release onto the underlying field 14 (e.g., plants and/or soil) through one or more nozzle assembly (ies) 24. Each nozzle assembly (ies) 24 may include, for example, a spray nozzle and an associated valve for regulating the flow rate of the agricultural product through the nozzle (and, thus, the application rate of the nozzle assembly (ies) 24), thereby allowing the desired spray characteristics of a spray fan of the agricultural product expelled from the nozzle to be achieved. In some instances, each valve may be selectively activated to direct an agricultural product towards a defined target. For instance, each valve may be selectively activated to deposit a suitable herbicide toward a detected/identified weed and/or a nutrient toward a detected/identified crop.

In several embodiments, the UAV(s) 12 may include one or more sensors 26 to collect data associated with the UAV 12, an additional UAV 12, one or more objects within the field 14, a topology for the field 14, and/or any other information. For instance, the UAV(s) 12 may selectively activate one or more nozzle assembly (ies) 24 to deposit a suitable herbicide toward a detected/identified weed and/or a nutrient toward a detected/identified crop based on data from the one or more sensors 26. In some examples, the sensors 26 can include one or more spray sensors, orientation sensors, pressure sensors, propulsion sensors, energy sensors, a weather station, and/or any other sensing assembly. For instance, suitable spray sensors (e.g., an imaging sensor, a LIDAR, a RADAR, or any other suitable type of sensor) may be configured to capture data related to the one or more spray fans. Similarly, suitable orientation sensors (e.g., an imaging sensor, a LIDAR, a RADAR sensor, a Hall effect sensor, a gyroscope sensor, a magnetometer sensor, an accelerometer sensor, a yaw-rate sensor, a piezoelectric sensor, a position sensor, a complementary metal-oxide-semiconductor (CMOS) sensor, a pressure sensor, a capacitive sensor, an ultrasonic sensor, or any other suitable type of sensor) may be configured to capture data related to a position, angle, displacement, distance, speed, acceleration of the UAV 12. Suitable pressure sensors (e.g., a diaphragm pressure sensor, a piston pressure sensor, a strain gauge-based pressure sensor, an electromagnetic pressure sensor, or any other suitable type of sensor) may be configured to capture data indicative of the pressure of the agricultural product being supplied to or through the nozzle assembly (ies) 24. Suitable propulsion sensors may be configured to capture data related to one or more components of the propulsion system 16. Suitable energy sensors may be configured to capture data related to an amount of usable energy for the UAV 12. In examples in which the sensor(s) 26 corresponds to or includes a camera, a single-spectrum camera or a multi-spectrum camera may be implemented and configured to capture image data, for example, in the visible light range and/or infrared spectral range. Additionally, in various embodiments, the cameras may correspond to a single lens camera configured to capture two-dimensional image data or a stereo cameras having two or more lenses with a separate image imaging device for each lens to allow the cameras to capture stereographic or three-dimensional image data.

In addition, the UAV(s) 12 may also support one or more additional components, such as an on-board computing device(s) 28. In general, the UAV computing device(s) 28 may be configured to control the operation of the UAV 12, such as by controlling the propulsion system 16 of the UAV 12 to cause the UAV 12 to be moved relative to the field 14. For instance, in some embodiments, the UAV 12 computing device(s) 28 may be configured to receive flight plan data associated with a proposed flight plan for the associated UAV 12, such as a flight plan selected such that the UAV 12 makes one or more passes across the field 14 in a manner that allows the agricultural product to be applied to a defined target. Based on such data, the UAV 12 computing device(s) 28 may control the operation of the UAV 12 such that the UAV 12 is flown across the field 14 according to the proposed flight plan.

Additionally, as shown in FIG. 1, the system 10 may also include one or more computing system(s) 30 separate from or remote to the UAV(s) 12. In several embodiments, the computing system(s) 30 may be communicatively coupled to the UAV computing device(s) 28 to allow data to be transmitted between the UAV(s) 12 and the computing system(s) 30. For instance, in various embodiments, the computing system(s) 30 may be configured to transmit instructions or data to the UAV computing device(s) 28 that is associated with the flight plan across the field 14. Similarly, the UAV computing device(s) 28 may be configured to transmit or deliver the data collected by the sensor(s) 26 to the computing system(s) 30.

The computing system(s) 30 may correspond to a stand-alone component or may be incorporated into or form part of a separate component or assembly of components. For example, in various embodiments, the computing system(s) 30 may form part of a base station 32. In such an embodiment, the base station 32 may be portable, such as by being transportable to a location within or near the field 14, or the base station 32 may be disposed at a fixed location, such as a farm building or central control center, which may be proximal or remote to the field 14. In instances in which the base station 32 is portable, the base station 32 may include one or more base station wheels 34. The one or more base station wheels 34 may be configured to support the base station 32 relative to the field 14. In some embodiments, the base station 32 may also include a powertrain control system 36 that may include a power plant, such as an engine, a motor, or a hybrid engine-motor combination, a transmission or hydraulic propel system configured to transmit power from the power plant to the one or more base station wheels 34, and/or a brake system.

As shown in FIG. 1, in various embodiments, the base station 32 may further include various systems and components for supporting the UAV(s) 12. For instance, the base station 32 may include a docking station(s) 38, which may be positioned on a top portion of the base station 32 and/or at any other location. The base station 32 may further include one or more refill tank(s) 40 and/or a power source station(s) 42. The refill tank(s) 40 may be configured to store additional agricultural products, a rinse fluid, and/or any other fluid that may be transferred to the UAV(s) 12, such as when the UAV(s) 12 is located on the docking station(s) 38. The power source station(s) 42 may store one or more power sources, such as one or more batteries (e.g., battery 18), that may be operably couplable with the UAV 12. In some instances, the power sources may be transferred from the power source station(s) 42 to the docking station(s) 38 (or any other location) through a power transfer assembly (ies) 44 such that the power source within a UAV 12 may be replaced and/or refilled with supplemental energy. In some instances, instead of, or in addition to, the UAV(s) 12 using replaceable and/or rechargeable batteries 18, the UAV(s) 12 may run on other fuels (e.g., gas, hydrogen, etc.), in which case the power source station(s) 42 may store such other fuels and the transfer assembly (ies) 44 may be used to replace/refill the applicator tank(s) 20 on the UAV(s) 12 for storing such other fuels.

With further reference to FIG. 1, in other embodiments, the one or more computing systems 30 may correspond to or form part of a remote cloud-based system 46. For instance, the UAV(s) 12, the base station 32, and/or an electronic device 48 may be communicatively coupled with one another and/or one or more remote sites, such as a remote server 50 via a network/cloud 52 to provide data and/or other information therebetween. The network/cloud 52 represents one or more systems by which the UAV(s) 12, the base station 32, and/or the electronic device 48 may communicate with the remote server 50. The network/cloud 52 may be one or more of various wired or wireless communication mechanisms, including any desired combination of wired and/or wireless communication mechanisms and any desired network topology (or topologies when multiple communication mechanisms are utilized). Example communication networks 52 include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 52 in FIG. 1). The verbal image has been formalized in the newer concept of cloud computing. The National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 52.

The server 50 may be one or more computing devices, each of which may include at least one processor and at least one memory, the memory storing instructions executable by the processor, including instructions for carrying out various steps and processes. The server 50 may include or be communicatively coupled to a data store 54 for storing collected data as well as instructions for the UAV(s) 12, the base station 32, and/or the electronic device 48 with or without intervention from a user, the UAV(s) 12, the base station 32, and/or the electronic device 48. Moreover, the server 50 may be capable of analyzing initial or raw sensor data received from the UAV(s) 12, the electronic device 48, and/or the base station 32, and final or post-processing data (as well as any intermediate data created during data processing). Accordingly, the instructions provided to any one or more of the UAV(s) 12, the base station 32, and/or the electronic device 48 may be determined and generated by the server 50 and/or one or more cloud-based application(s) 56. In such instances, a user interface for the UAV(s) 12, a user interface for the base station 32, and/or the electronic device 48 may be a dummy device that provides various notifications based on instructions from the network/cloud 52.

With further reference to FIG. 1, the server 50 also generally implements features that may enable the UAV(s) 12, the base station 32, and/or the electronic device 48 to communicate with cloud-based application(s) 56. Communications from the electronic device 48 can be directed through the network/cloud 52 to the server 50 and/or cloud-based application(s) 56 with or without a networking device, such as a router and/or modem. Additionally, communications from the cloud-based application(s) 56, even though these communications may indicate the UAV(s) 12, the base station 32, and/or the electronic device 48 as an intended recipient, can also be directed to the server 50. The cloud-based application(s) 56 are generally any appropriate services or applications 56 that are accessible through any part of the network/cloud 52 and may be capable of interacting with the electronic device 48.

In various examples, the UAV(s) 12, the base station 32, and/or the electronic device 48 can be feature-rich with respect to communication capabilities, i.e. have built-in capabilities to access the network/cloud 52 and any of the cloud-based application(s) 56 or can be loaded with, or programmed to have, such capabilities. The UAV(s) 12, the base station 32, and/or the electronic device 48 can also access any part of the network/cloud 52 through industry-standard wired or wireless access points, cell phone cells, or network nodes. In some examples, users can register to use the remote server 50 through the UAV(s) 12, the base station 32, and/or the electronic device 48, which may provide access to the UAV(s) 12, the base station 32, and/or the electronic device 48 and/or thereby allow the server 50 to communicate directly or indirectly with the UAV(s) 12, the base station 32, and/or the electronic device 48. In various instances, the UAV(s) 12, the base station 32, and/or the electronic device 48 may also communicate directly, or indirectly, with others of the UAV(s) 12, the base station 32, and/or the electronic device 48, or one of the cloud-based application(s) 56 in addition to communicating with or through the server 50. According to some examples, the UAV(s) 12, the base station 32, and/or the electronic device 48 can be preconfigured at the time of manufacture with a communication address (e.g. a URL, an IP address, etc.) for communicating with the server 50 and may or may not have the ability to upgrade or change or add to the preconfigured communication address.

Referring still to FIG. 1, when a new cloud-based application(s) 56 is developed and introduced, the server 50 can be upgraded to be able to receive communications for the new cloud-based application(s) 56 and to translate communications between the new protocol and the protocol used by the UAV(s) 12, the base station 32, and/or the electronic device 48. The flexibility, scalability, and upgradeability of current server technology render the task of adding new cloud-based application protocols to the server 50 relatively quick and easy.

In several embodiments, an application interface 58 may be operably coupled with the cloud 52 and/or the application 56. The application interface 58 may be configured to receive data related to the UAV(s) 12, the base station 32, and/or the electronic device 48. In various embodiments, one or more inputs related to the field data may be provided to the application interface 58. For example, a farmer, a vehicle user, a company, or other persons may access the application interface 58 to enter the inputs related to the field data. Additionally, or alternatively, the inputs related to the field data may be received from the remote server 50. For example, the inputs related to the field data may be received in the form of software that can include one or more objects (e.g., crops (crop rows, etc.), weeds, landmarks, targets, and/or the like within the field 14), agents, lines of code, threads, subroutines, databases, application programming interfaces (APIs), or other suitable data structures, source code (human-readable), object code (machine-readable). In response, the system 10 may update any input/output based on the received inputs. The application interface 58 can be implemented in hardware, software, or a suitable combination of hardware and software, and which can be one or more software systems operating on a general-purpose processor platform, a digital signal processor platform, or other suitable processors.

In some examples, at various predefined periods and/or times, the UAV(s) 12, the base station 32, and/or the electronic device 48 may communicate with the server 50 through the network/cloud 52 to obtain the stored instructions, if any exist. Upon receiving the stored instructions, the UAV(s) 12, the base station 32, and/or the electronic device 48 may implement the instructions. In some instances, the UAV(s) 12, the base station 32, and/or the electronic device 48 can send event-related data to the server 50 for storage in the data store 54. This collection of event-related data can be accessed by any number of users, the UAV(s) 12, the base station 32, and/or the electronic device 48 to assist with application processes.

In some instances, the electronic device 48 may also access the server 50 to obtain information related to stored events. The electronic device 48 may be a mobile device, tablet computer, laptop computer, desktop computer, watch, virtual reality device, television, monitor, or any other computing device or another visual device.

In various embodiments, the data used by the UAV(s) 12, the base station 32, the electronic device 48, the remote server 50, the data store 54, the application 56, the application interface 58, and/or any other component described herein for any purpose may be based on data provided by the one or more sensors 26 and/or third-party data that may be converted into comparable data that may be used independently or in conjunction with data collected from the one or more sensors 26.

In various examples, the server 50 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 50 through the network/cloud 52 and may be used to generate a predictive evaluation of the field 14. In some instances, the machine learning engine may allow for changes to a map of the field 14 to be updated without human intervention.

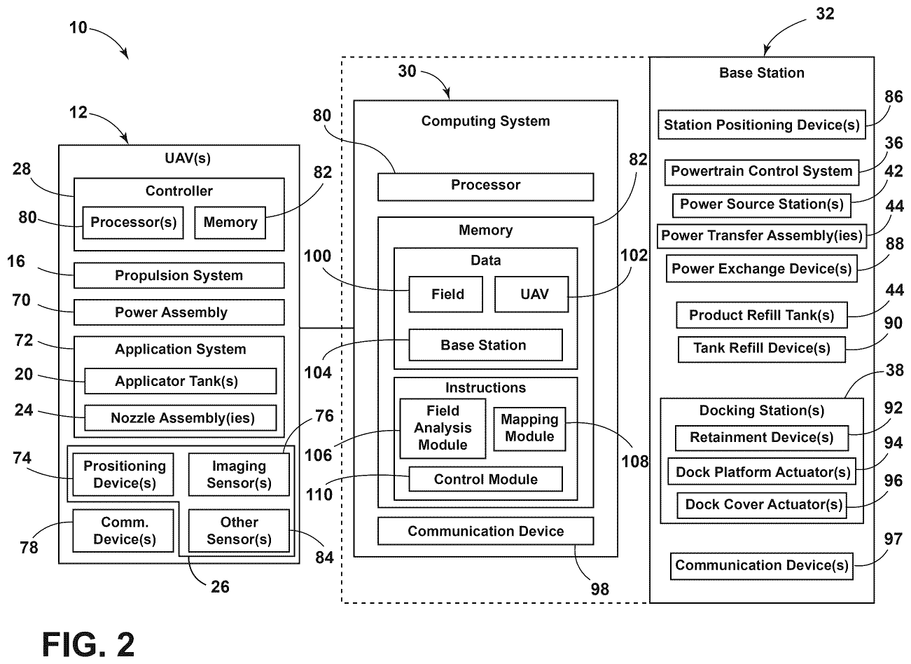

Referring now to FIG. 2, a schematic view of components of the system 10 of FIG. 1 is illustrated in accordance with aspects of the present subject matter. Particularly, the system 10 is described in FIG. 2 with reference to one of the UAV(s) 12, the remote cloud-based system 46, and the base station 32 from FIG. 1. It should be appreciated, however, that, in other embodiments, the disclosed system 10 may have any other suitable system configuration or architecture and/or may incorporate any other suitable components and/or combination of components that generally allow the system 10 to function as described herein.

As described above with reference to FIG. 1, the system 10 may include one or more UAV(s) 12, such as the UAV(s) 12, where each UAV 12 may include and/or be configured to support various components, such as one or more UAV computing device(s) 28, propulsion systems 16, power assemblies, application system 72, and sensors 26. For instance, the UAV 12 may include the on-board computing device(s) 28, the propulsion system(s) 16, one or more power assembly (ies) 70 (e.g., including the battery (ies) 18), application system 72 (e.g., including the applicator tank(s) 20, the plumbing component(s) 22, the nozzle assembly (ies) 24, etc.), the sensor(s) 26 (e.g., including one or more positioning device(s) 74, one or more imaging sensor(s) 76, etc.), one or more communication devices 78, and/or one or more other devices.

In general, the UAV computing device(s) 28 may correspond to any suitable processor-based device(s), such as a computing device or any combination of computing devices. Thus, in several embodiments, the UAV computing device(s) 28 may include one or more processor(s) 80 and associated memory 82 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 82 of the UAV computing device(s) 28 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory 82 may generally be configured to store suitable computer-readable instructions that, when implemented by the processor(s) 80, configure the UAV computing device(s) 28 to perform various computer-implemented functions. It should be appreciated that the UAV computing device(s) 28 may also include various other suitable components, such as a communications circuit or module, a network interface, one or more input/output channels, a data/control bus, and/or the like.

In several embodiments, the UAV computing device(s) 28 may be configured to control the operation of one or more other components of the UAV 12. For instance, the UAV computing device(s) 28 may be configured to control the propulsion system 16 of the UAV 12. For instance, as indicated above, the UAV computing device(s) 28 may be configured to control the propulsion system 16 in a manner that allows the UAV 12 to be flown across a field 14 according to a predetermined or desired flight plan. In this regard, the propulsion system 16 may include any suitable components that allow for the trajectory, speed, and/or altitude of the UAV 12 to be regulated, such as one or more power sources (e.g., one or more batteries 18 of the power assembly (ies) 70), one or more drive sources (e.g., one or more motors and/or engines), and one or more lift/steering sources (e.g., propellers, blades, wings, rotors, and/or the like). Similarly, as indicated above, the UAV computing device(s) 28 may be configured to control the application system 72 in a manner that allows the UAV 12 to selectively apply agricultural product to the field 14 as the UAV 12 performs the flight plan. In this regard, the application system 72 may include any suitable components that allow for the dispensing of agricultural product by the UAV 12 to be regulated, such as the applicator tank(s) 20, the plumbing component(s) 22, the nozzle assembly (ies) 24, etc.

In various embodiments, the computing device(s) 28 may be configured to monitor the position of the UAV 12 to control the propulsion system 16 and/or the application system 72. For instance, the positioning device(s) 74 may be configured to determine the location of the UAV 12 within the field 14 using a satellite navigation position system (e.g. a GPS, a Galileo positioning system, a Global Navigation satellite system (GLONASS), a BeiDou Satellite Navigation and Positioning system, and/or the like), and/or a dead reckoning device. In such embodiments, the location determined by the positioning device(s) 74 may be transmitted to the UAV computing device(s) 28 (e.g., in the form of coordinates) and stored within the memory 82 for subsequent processing and/or analysis. By monitoring the location of the UAV 12 as a pass is being made across the field 14, the sensor data acquired via the imaging sensor(s) 76 may be geo-located within the field 14. For instance, in various embodiments, the location coordinates derived from the positioning device(s) 74 and the sensor data generated by the imaging sensor(s) 76 may both be time-stamped. In such an embodiment, the time-stamped data may allow the sensor data to be matched or correlated to a corresponding set of location coordinates received or derived from the positioning device(s) 74, thereby allowing a field map to be generated that locates various objects (e.g., targets, weeds, crops, landmarks, etc.) within the field 14 relative to one another.

It should be appreciated that the UAV 12 may also include any other suitable components. For instance, in addition to the imaging sensor(s) 76, the UAV 12 may also include various other sensors 84, such as one or more inertial measurement units for monitoring the orientation of the UAV 12 and/or one or more altitude sensors for monitoring the pose of the UAV 12 relative to the ground. As used herein, “pose” includes the position and orientation of an object, such as the position and orientation of a vehicle, in some reference frame. Moreover, the UAV 12 may include a communications device(s) 78 to allow the UAV computing device(s) 28 to be communicatively coupled to one or more other system components. The communications device 78 may, for example, be configured as a wireless communications device (e.g., an antenna or transceiver) to allow for the transmission of wireless communications between the UAV computing device(s) 28 and one or more other remote system components.

Moreover, as described above with reference to FIG. 1, the system 10 may include or more base stations, such as the base station 32, where each base station 32 may include and/or be configured to support various components, such as one or more computing devices, propulsion systems, UAV refueling-related components and sensors 26. For instance, the base station 32 may include the base station computing devices or system(s) 30, the powertrain control system 36, and one or more station positioning device(s) 86. Moreover, the base station 32 may include UAV refueling-related components, such as one or more power-related refueling components (e.g., the powertrain control system 36, the power source station(s) 42, the power transfer assembly (ies) 44, one or more power exchange device(s) 88, and/or the like), one or more agricultural product-related refueling components (e.g., the refill tank(s) 40, one or more tank refill device(s) 90, and/or the like), and one or more docking station control components (e.g., one or more retainment devices 92, one or more dock platform actuator(s) 94, one or more dock cover actuator(s) 96, and/or the like). Additionally, while not shown, the base station 32 may include one or more other devices.

In several embodiments, the computing system(s) 30 may be configured to control the operation of one or more other components of the base station 32. For instance, the computing system(s) 30 may be configured to control the powertrain control system 36 of the base station 32. For instance, the base station 32 may be configured to control the powertrain control system 36 in a manner that allows the base station 32 to move. In this regard, the powertrain control system 36 may include any suitable components that allow for the trajectory, speed, and/or the like of the base station 32 to be regulated, such as one or more power sources, one or more drive sources (e.g., one or more motors and/or engines), and/or one or more steering sources. Similarly, as indicated above, the computing system(s) 30 may be configured to control the power-related refueling component(s), the agricultural product-related refueling component(s), and/or the docking station control component(s) in a manner that supports refilling/refueling servicing of the UAV(s) 12.

In various embodiments, the computing system(s) 30 may be configured to monitor the position of the base station 32 to control the propulsion system 16. For instance, the base station positioning device(s) 86 of the base station 32, similar to the positioning device(s) 74, may be configured to determine the location of the base station 32 relative to the field 14 using a satellite navigation position system (e.g. a GPS, a Galileo positioning system, a Global Navigation satellite system (GLONASS), a BeiDou Satellite Navigation and Positioning system, and/or the like), and/or a dead reckoning device. In such embodiments, the location determined by the positioning device(s) 86 may be transmitted to the computing system(s) 30 (e.g., in the form of coordinates) and stored within the memory 82 for subsequent processing and/or analysis. In some instances, the location of the base station 32 may be monitored with respect to the location of one or more of the UAV(s) 12.

It should be appreciated that the base station 32 may also include any other suitable components. For instance, the base station 32 may also include various other sensors 26, such as one or more inertial measurement units (not shown) for monitoring the orientation of the base station 32. As used herein, “pose” includes the position and orientation of an object, such as the position and orientation of a vehicle, in some reference frame. Moreover, the base station 32 may include a communications device(s) 97, 98 to allow the computing system(s) 30 to be communicatively coupled to one or more other system components. The communications device 97, 98 may, for example, be configured as a wireless communications device (e.g., an antenna or transceiver) to allow for the transmission of wireless communications between the computing system(s) 30 and one or more other remote system components.

As indicated above, the computing system(s) 30 may correspond to a stand-alone component or may be incorporated into or form part of a separate component or assembly of components. For example, the computing system(s) 30 may be incorporated into or form part of the UAV(s) 12, the base station(s) 32, and/or the cloud-based system 46.

In various embodiments, the memory 82 of the computing system(s) 30 may include one or more databases for storing information. For instance, as shown in FIG. 2, the memory 82 may include a field database 100 storing data indicative of field conditions, topology, and/or the like, such as data received from the imaging sensor(s) 76 during a pre-emergence condition (e.g., prior to a seed planting operation in the field 14 or following such operation but prior to the emergence of the plants), during a growing condition (following emergence of plants, prior to harvesting), and/or the like. The image data received may be raw or processed data of one or more portions of the field 14. The field database 100 may also store various forms of data that a related to identified objects within and/or proximate to the field 14. For example, the objects may include targets and/or landmarks that may be used to relocate the targets during a subsequent operation.

In one or more embodiments, the memory 82 may include a UAV database 102 for storing data associated with the UAV(s) 12. For instance, the UAV database 102 may include information associated with the configuration of the UAV(s) 12 (e.g., fill tank capacity, battery requirements, and/or the like), the position data from the positioning device(s) 74 on the UAV(s) 12, data indicative of fill level(s) of the applicator tank(s) 20 on the UAV(s) 12, data indicative of a power level of the power assembly (ies) 70 (e.g., estimated remaining battery life of the battery (ies) 18) on the UAV(s) 12, and/or the like.

Similarly, the memory 82 may include a base station database 104 for storing data associated with the base station(s) 32. For instance, the base station database 104 may include information about the configuration of the base station 32 (e.g., number of docking station(s) 38, capacity of the refill tank(s) 40, capacity of the power source station(s) 42, and/or the like), the position data generated by the station positioning device(s) 86 of the base station(s) 32, data indicative of fill level(s) of the refill tank(s) 40 of the base station(s) 32, data indicative of the status of battery (ies) 18 and/or fill level of fuel at the power source station(s) 42, data indicative of the status of the docking station(s) 38, and/or the like.

Referring still to FIG. 2, in several embodiments, the instructions stored within the memory 82 of the computing system(s) 30 may be executed by the processor(s) 80 to implement a field analysis module 106. In general, the field analysis module 106 may be configured to analyze the data of the field database 100 to allow the computing system(s) 30 to detect/identify the type of various objects in the field 14. In this regard, the computing system(s) 30 may include any suitable processing algorithms stored within its memory 82 or may otherwise use any suitable data processing techniques on the data of the field database 100. For instance, in some embodiments, the computing system(s) 30 may be able to distinguish between weeds and emerging/standing crops. Additionally, or alternatively, in some embodiments, the computing system(s) 30 may be configured to distinguish between weeds and emerging/standing crops, such as by identifying crop rows of emerging/standing crops and then inferring that plants positioned between adjacent crop rows are weeds.

Moreover, the instructions stored within the memory 82 of the computing system(s) 30 may be executed by the processor(s) 80 to implement a mapping module 108 that is configured to generate one or more maps of the field 14 based on the data of the field database 100. It should be appreciated that, as used herein, a “map” may generally correspond to any suitable dataset that correlates data to various locations within a field 14. Thus, for example, a map may simply correspond to a data table that correlates field data to various locations within the field 14 or may correspond to a more complex data structure, such as a geospatial numerical model that can be used to identify various objects in the field data and determine a position of each object within the field 14, which may, for instance, then be used to generate a graphically displayed map or visual indicator.

Referring still to FIG. 2, in some embodiments, the instructions stored within the memory 82 of the computing system(s) 30 may also be executed by the processor(s) 80 to implement a control module 110. In various instances, the control module 110 may be configured to instruct the power transfer assembly (ies) 44 to transfer an independently identifiable battery 18 for an aerial vehicle from a power source station(s) 42 to a power exchange device(s) 88. In some cases, the control module 110 may activate a power transfer assembly (ies) 44 to transfer an independently identifiable battery 18 from the power source station(s) 42 to the power exchange device(s) 88 based at least in part on the state of charge of the independently identifiable battery 18 and/or any other information.

In general, the operating time for each of the UAV(s) (e.g., UAV(s) 12) of a swarm may be limited by the capacity of the applicator tanks 20 and/or the capacity of the batteries 18 (or onboard fuel tanks). When an applicator tank 20 is empty or a battery 18 (or onboard fuel tank) is about to run out, the UAV 12 may return to a base station (e.g., base station 32) for a refilling/refueling process. However, the applicator tank(s) 20 of each UAV 12 are typically manually refilled by an operator, and/or the battery (ies) 18 of each UAV 12 are manually swapped out (or the fuel tank is manually refilled) by an operator, where such manual servicing processes are time-consuming. Moreover, an operator may only effectively service one UAV 12 at a time. As such, the amount of operating time for UAV applicators is severely limited.

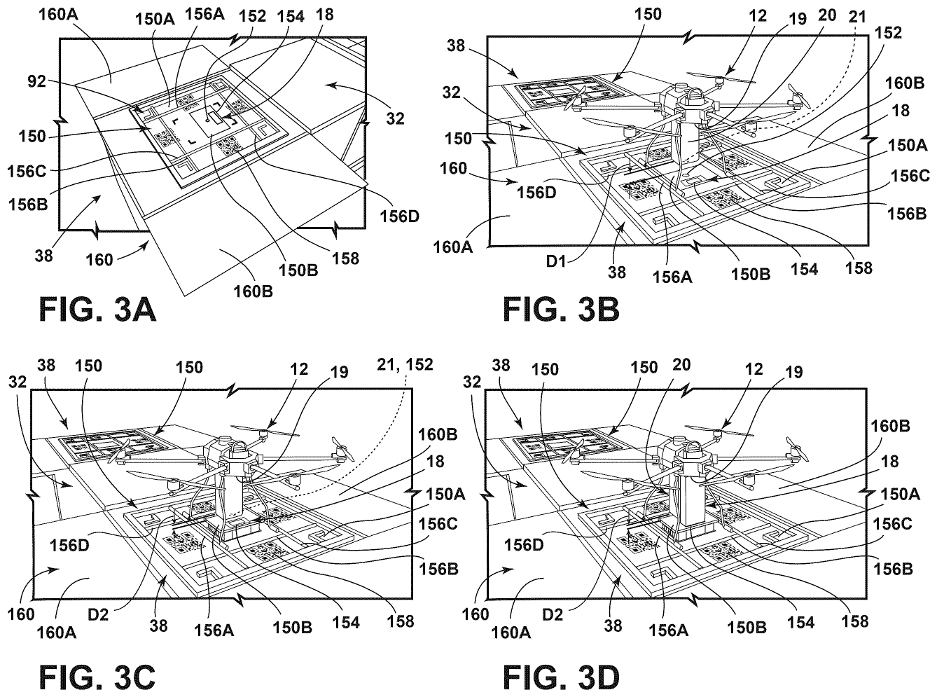

Thus, in accordance with aspects of the present subject matter, the base station 32 can service the UAV(s) 12, which reduces downtime for the UAV(s) 12 and increases the productivity of the swarm of UAV(s) 12. For instance, referring now to FIGS. 3A-3D, various views of an example docking station(s) 38 are illustrated in accordance with aspects of the present subject matter. For example, as shown in FIGS. 3A-3D, the base station 32 may include one or more docking station(s) 38, each of the docking station(s) 38 having a platform 150 on which a UAV (e.g., the UAV 12) may rest or land, where the docking station(s) 38 may facilitate a refilling or refueling process for the UAV 12 supported thereon. For instance, in the illustrated embodiment shown in FIGS. 3A-3D, the base station 32 includes two docking station(s) 38, where the docking station(s) 38 are spaced apart. However, it should be appreciated that the base station 32 may include any other suitable number of docking station(s) 38, such as only one docking station(s) 38, or three or more docking station(s) 38. Generally, the more docking station(s) 38, the higher the potential productivity of a swarm or group of the UAV(s) 12.

In some instances, the platform 150 is supported on a roof or other exterior surface of the base station 32 such that the platform 150 may be easily accessible by the UAV(s) 12. The platform 150 may define at least one opening configured to align with the applicator tank 20 (e.g., a tank port 21 of the applicator tank 20) and the battery 18 (e.g., a battery port 19 for receiving a battery 18) of a UAV 12 supported on the platform 150, where the applicator tank 20 and the battery 18 are configured to be serviced through the at least one opening. For instance, the applicator tank 20 may be configured to be connected to the refill tank(s) 40 of the base station 32 through the at least one opening. Similarly, the battery port 19 may be configured to receive a battery 18 from the base station 32 through the at least one opening. For instance, in some examples, the at least one opening includes a first opening 152 and a second opening 154, where the first opening 152 is configured to align with the applicator tank 20 (e.g., a tank port 21 of the applicator tank 20) of the supported UAV 12, and the second opening 154 is configured to align with the battery 18 (e.g., a battery port 19 for receiving a battery 18) of the supported UAV 12. In some instances, the tank port 21 may be located on a lower surface of the applicator tank 20. Similarly, in some instances, the battery port 19 for receiving a battery (e.g., battery 18) is positioned on a lower surface of the main body of the UAV 12. However, it should be appreciated that any other suitable position of the tank port 21 and/or battery port 19 may instead, or additionally, be used.

In the illustrated embodiment, the platform 150 includes a first platform portion 150A and a second platform portion 150B, where the second platform portion 150B is movable relative to the first platform portion 150A to facilitate the servicing of the supported UAV 12. For instance, the second platform portion 150B (hereinafter referred to as “the second portion 150B”) may be movable relative to the first platform portion 150A (hereinafter referred to as “the first portion 150A”) between a standby position (FIGS. 3A and 3B) and a servicing position (FIGS. 3C and 3D). In one instance, as shown, the second portion 150B is at least partially surrounded by the first portion 150A, and the second portion 150B defines the at least one opening (e.g., the first and second openings 152, 154). In some embodiments, the second portion 150B is fully encircled by the first portion 150A.

Due to the second portion 150B being movable relative to the first portion 150A, a distance between a supported UAV 12 and the platform 150 is adjustable. For instance, as shown in FIG. 3A, when the platform 150 is waiting for a UAV 12 to land, the second portion 150B is in the standby position, where the second portion 150B may be substantially even with (or even below) the first portion 150A. As shown in FIG. 3B, when a UAV (e.g., UAV 12) initially contacts the first portion 150A, the portion of the UAV 12 having the tank port 21 and the battery port 19 extends at least partially over the second portion 150B, and the second portion 150B is spaced apart from the tank port 21 by a first distance D1 (and any battery 18 within the battery port 19). Thereafter, as shown in FIG. 3C, the second portion 150B may then be moved from the standby position into the servicing position, where the tank port 21 is a second distance D2 from the tank port 21 (and any battery 18 within the battery port 19), where the second distance D2 is smaller than the first distance D1. For instance, the second distance D2 may be essentially zero, such that the tank port 21 is brought into contact with the second portion 150B and the tank port 21 is connected through the first opening 152 to the refill tank(s) 40 (FIGS. 1 and 2), allowing the applicator tank 20 to be refilled from (or emptied to) the refill tank(s) 40 (e.g., by operating the tank refill device(s) 90 (FIG. 2)). Moreover, in FIG. 3D where the second portion 150B is still in the servicing position, a battery 18 may be moved (e.g., by the power transfer assembly (ies) 44 (FIG. 2)) from the base station 32 (e.g., from the power source station(s) 42 (FIG. 2) through the second opening 154 and into the battery port 19, or vice versa (moved from the battery port 19 through the second opening 154 to the power source station(s) 42 within the base station 32).

It should be appreciated that, by moving the second portion 150B between the standby position and the servicing position, damage to the UAV 12 (e.g., to the applicator tank 20 or attached battery 18) may be avoided when landing on the platform 150. However, it should be appreciated that, in other embodiments, the first portion 150A may instead, or additionally, move relative to the second portion 150B to provide the same benefit. Moreover, it should be appreciated that, in some embodiments, part of the second portion 150B defining the first opening 152 may move independently of part of the second portion 150B defining the second opening 154.

Moreover, in one or more embodiments, the platform 150 may include a retainment device (e.g., the retainment device 92) for centering and/or holding the UAV 12 in position during servicing. For instance, the platform 150 includes a plurality of holders 156 (e.g., including a first holder 156A, a second holder 156B, a third holder 156C, and a fourth holder 156D) movable relative to the platform 150. For example, the holders 156 move from a position closer to the outer perimeter of the first portion 150A of the platform 150, as in FIG. 3A, toward the second portion 150B until they at least partially vertically overlap (extend over) the legs (e.g. feet or flanges proximate to the lower ends of the legs) of the UAV 12, as shown in FIGS. 3B-3D. The movement of the holders 156 may be coordinated such that the legs of the UAV 12 are moved by the holders 156 until the tank port 21 and the battery port 19 align with the first and second openings 152, 154. Once the servicing operation is finished, the holders 156 may be moved back towards the position shown in FIG. 3A. It should be appreciated that, while the holders 156 are shown as being flat strips, the holders 156 may have any other suitable shape. It should also be appreciated that, in some instances, the UAV 12 may also include one or more features for selectively attaching or holding the UAV 12 the platform 150.

The dock platform actuator(s) 94 (FIG. 2) may be provided for moving the platform portion(s) 150A, 150B, and/or the holders 156. The dock platform actuator(s) 94 (FIG. 2) may be configured as any suitable type of actuator, such as a linear actuator (e.g., belt-driven, screw driven, and/or the like).

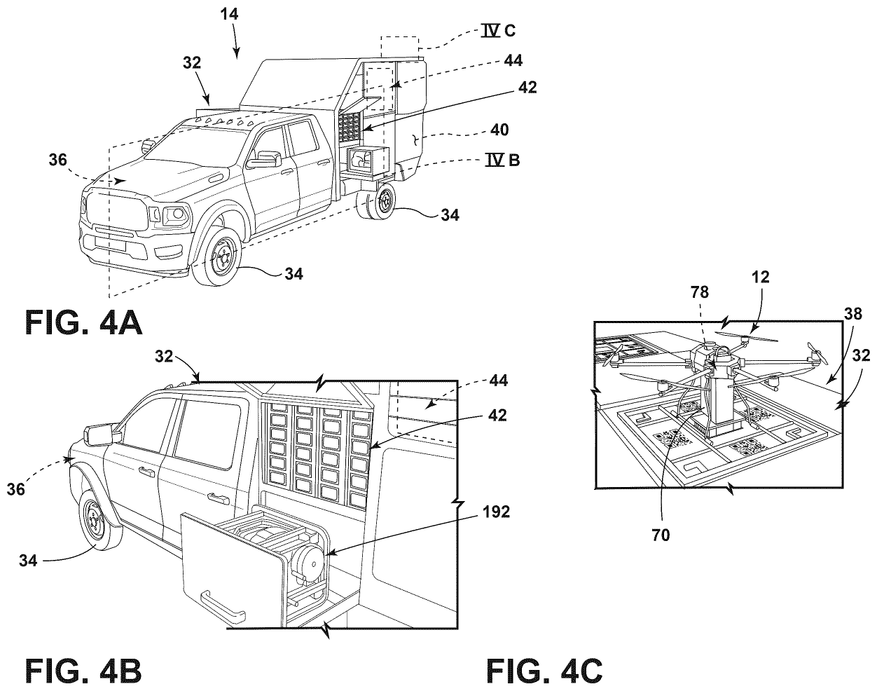

Referring now to FIGS. 4A-4C, the base station 32, the power source station(s) 42, and the docking station(s) 38 are respectively illustrated in accordance with various aspects of the present disclosure. In the illustrated example, the base station 32 is shown including a powertrain control system 36 that may include a power plant, such as an engine, a motor, or a hybrid engine-motor combination, a transmission or hydraulic propel system configured to transmit power from the power plant to the one or more base station wheels 34, and/or a brake system. In other embodiments, the base station 32 may be free of the powertrain control system 36 and/or the base station wheels 34 without departing from the scope of the present disclosure.

In some instances, the power source station(s) 42 may be operably coupled with and/or otherwise supported by the base station 32. However, in some embodiments, the power source station(s) 42 may be a separate component that is remote from the base station 32. As provided, the power source station(s) 42 may store one or more power sources, such as one or more batteries (e.g., battery 18), that may be operably couplable with the UAV 12. In some instances, the power sources may be transferred from the power source station(s) 42 to the docking station(s) 38 (or any other location) through a power transfer assembly (ies) 44 such that the power source within a UAV 12 may be replaced and/or refilled with supplemental energy. In some instances, instead of, or in addition to, the UAV(s) 12 using replaceable and/or rechargeable batteries 18, the UAV(s) 12 may run on other fuels (e.g., gas, hydrogen, etc.), in which case the power source station(s) 42 may store such other fuels and the transfer assembly (ies) 44 may be used to replace/refill tank(s) 40 on the UAV(s) 12 for storing such other fuels.

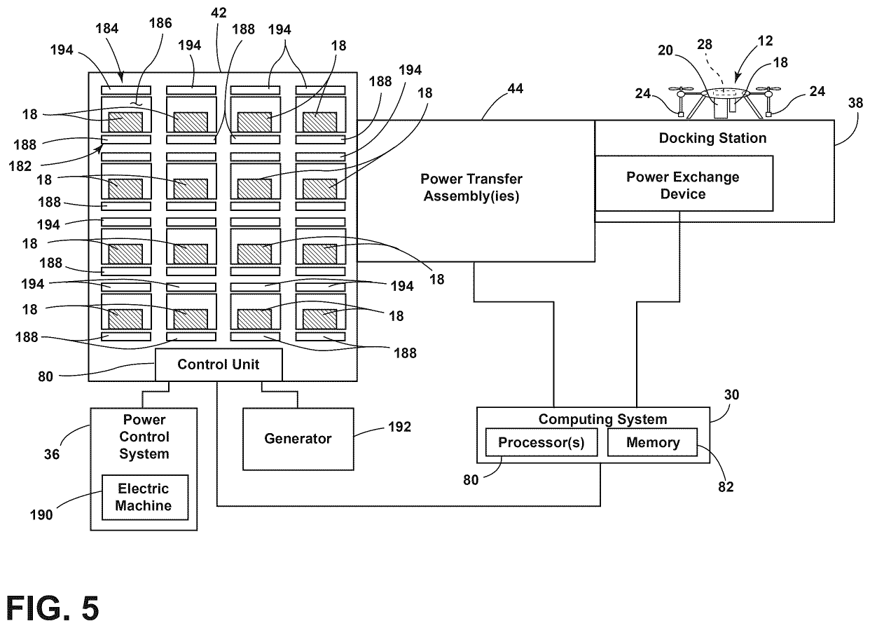

With reference to FIG. 5, various components operably coupled with the power source station(s) 42 are illustrated in accordance with various aspects of the present disclosure. In some cases, the power source station(s) 42 can include a control unit 180. In general, the control unit 180 may correspond to any suitable processor-based device(s), such as a computing device or any combination of computing devices. Thus, in several embodiments, the control unit 180 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the control unit 180 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the control unit 180 to perform various computer-implemented functions. It should be appreciated that the control unit 180 may also include various other suitable components, such as a communications circuit or module, a network interface, one or more input/output channels, a data/control bus, and/or the like.

In several embodiments, the control unit 180 may be configured to control the operation of one or more other components of the power station, provide electrical power to one or more other components of the power station, etc. For instance, the control unit 180 may be configured to control a charging system 182 and/or an identification system 184.

In some cases, the power source station(s) 42 may define one or more storage compartments 186 that are configured to retain a respective battery 18 therein. In some instances, the charging system 182 may include respective charging assembly (ies) 188 associated with each (or any) of the compartments. In various examples, the charging assembly (ies) 188 may be respective charge ports that physically mate with the battery 18 to supply power thereto. Additionally or alternatively, the charging assembly (ies) 188 may be configured to wirelessly transmit power to the respective batteries.

In various examples, power may be transferred from the powertrain control unit 180, with the use of an electric machine 190, and/or a generator 192 to the control unit 180 for distribution to the charging system 182. For example, the power plant within the powertrain control system 36 may be used to generate electrical power that is then transferred to the power source station(s) 42. Additionally or alternatively, a generator 192 may be used to generate electrical power for the power source station(s) 42. In general, the generator 192 may be configured as any device that converts motion-based power (potential and kinetic energy) or fuel-based power (chemical energy) into electric power for use by the power source station(s) 42.

The identification system 184 may be configured to identify each specific battery 18 within the power source station(s) 42. The identification system 184 may include one or more sensing device(s) 194 configured to identify each of the independently identifiable batteries within the power source station(s) 42. In some cases, a sensing device(s) 194 may be associated with each of the one or more storage compartments 186. For example, each of the batteries may include an identifying mark that is associated with a specific battery 18, such as an imaged code, a communicative device, such as a Radio Frequency Identification (RFID) system, and/or any other practicable feature. As such, in some instances, each of the batteries 18 may be independently identifiable such that the computing system(s) 30, the UAV computing device(s) 28, and/or the control unit 180 may be capable of identifying one or more of the batteries 18 separately from at least one other battery 18. The independently identifiable characteristic allows for the batteries 18 to be monitoring, transferred, and/or coupled with the UAV(s) 12 once a battery 18 has been identified.

In some embodiments, the computing system(s) 30 and/or the UAV computing device(s) 28 may communicate with the control unit 180. In such instances, the control unit 180 may initiate a charging mode for any of the charging assembly (ies) 188, identify which batteries are sufficiently charged, and/or perform any other task. The control unit 180, the computing system(s) 30, and/or the UAV computing device(s) 28 may, in turn, identify a specific battery to be transferred from the power source station(s) 42 to the docking station(s) 38 for attachment to a defined UAV 12. The battery to be transferred may be determined based on a variety of factors, including a specific flight map for the UAV 12, the flight map of one or more other UAV(s) 12, the status of the battery compared to other batteries within the power source station(s) 42, and/or any other variable. In various examples, the power transfer assembly (ies) 44 can include various components for transferring an identified battery to the power exchange device(s) 88.

Once the identified battery is transferred to the power exchange device(s) 88 and the UAV 12 is positioned on a docking station(s) 38, the identified battery may be operably coupled with the UAV 12 and a previously used battery from the UAV 12 may be transferred to the power source station(s) 42.

In examples in which the UAV 12 runs on other fuels (e.g., gas, hydrogen, etc.), the power source station(s) 42 may store such other fuels, and the transfer assembly (ies) 44 may be used to replace/refill tank(s) 40 on the UAV(s) 12 for storing such other fuels. Moreover, the control unit 180 and/or the power transfer assembly (ies) 44 may be configured to transfer the fuel from the power source station(s) 42 to the power exchange device(s) 88.

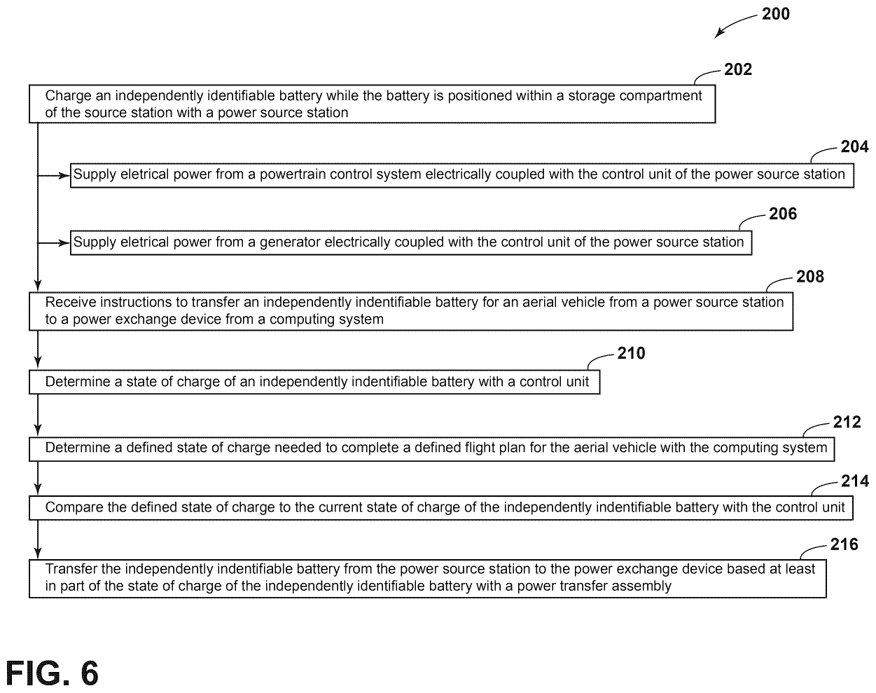

Referring now to FIG. 6, a flow diagram of some embodiments of a method 200 for an agricultural operation is illustrated in accordance with aspects of the present subject matter. In general, the method 200 will be described herein with reference to the one or more UAV(s), and the system 10 described above with reference to FIGS. 1-5. However, it will be appreciated by those of ordinary skill in the art that the disclosed method 200 may generally be utilized with any suitable agricultural vehicle and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 can include charging the independently identifiable battery while the battery is positioned within a storage compartment of the power source station with the power source station. As provided herein, the power source station may store one or more power sources, such as one or more batteries that may be operably couplable with the UAV. In some instances, instead of, or in addition to, the UAV(s) using replaceable and/or rechargeable batteries, the UAV(s) may run on other fuels (e.g., gas, hydrogen, etc.), in which case the power source station may store such other fuels.

In some cases, at (204), the method 200 can include supplying electrical power from a powertrain control system electrically coupled with the control unit of the power source station. Additionally or alternatively, at (206), the method 200 can include supplying electrical power from a generator electrically coupled with the control unit of the power source station.

At (208), the method 200 can include receiving instructions to transfer an independently identifiable battery for an aerial vehicle from a power source station to a power exchange device from a computing system. The computing systems may be separate from or remote to the UAV(s). In several embodiments, the computing system may be communicatively coupled to the UAV computing device to allow data to be transmitted between the UAV and the computing system. For instance, in various embodiments, the computing system may be configured to transmit instructions or data to the UAV computing device that is associated with the flight plan across the field. Similarly, the UAV computing device may be configured to transmit or deliver the data collected by the sensor to the computing system.

At (210), the method 200 can include determining, with a control unit, a state of charge of an independently identifiable battery. At (212), the method 200 can include determining, with the computing system, a defined state of charge needed to complete a defined flight plan for the aerial vehicle. At (214), the method 200 can include comparing, with the control unit, the defined state of charge to the current state of charge of the independently identifiable battery.

At (216), the method 200 can include transferring, with a power transfer assembly, the independently identifiable battery from the power source station to the power exchange device based at least in part on the state of charge of the independently identifiable battery and/or any other information.

In various examples, the method 200 may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the any of the modules or algorithms described herein. In some instances, the machine learning engine may allow for changes to the modules or algorithms to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing device, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
an aerial vehicle configured to apply an agricultural product to a defined location within a field; and
a base station including a docking station, the base station comprising:
a power source station configured to store independently identifiable batteries;
a power exchange device configured to install one of the independently identifiable batteries within the aerial vehicle;
a power transfer device configured to transfer the one of the independently identifiable batteries to the power exchange device; and
a control unit configured to:
identify each of the independently identifiable batteries; and
provide power to one or more of the independently identifiable batteries stored within the power source station.

2. The agricultural system of claim 1, wherein the power source station defines one or more storage compartments that respectively house the independently identifiable batteries.

3. The agricultural system of claim 2, further comprising:
a charging system including respective charging assemblies associated with each of the one or more storage compartments.

4. The agricultural system of claim 3, wherein the charging assemblies are configured as respective charge ports that physically mate with the independently identifiable batteries to supply power thereto.

5. The agricultural system of claim 3, wherein the charging assemblies are configured to wirelessly transmit power to the respective batteries.

6. The agricultural system of claim 3, further comprising:
a powertrain control system electrically coupled with the control unit and configured to supply power to the charging system.

7. The agricultural system of claim 3, further comprising:
a generator electrically coupled with the control unit and configured to supply power to the charging system.

8. The agricultural system of claim 3, further comprising:
an identification system including one or more sensing devices configured to identify each of the independently identifiable batteries within the power source station.

9. The agricultural system of claim 8, wherein a respective sensing device of the one or more sensing devices is associated with each of the one or more storage compartments.

10. The agricultural system of claim 9, wherein the sensing device includes an RFID system.

11. A method for an agricultural operation, the method comprising:
receiving, from a computing system, instructions to transfer an independently identifiable battery for an aerial vehicle from a power source station to a power exchange device;
determining, with a control unit, a state of charge of the independently identifiable battery; and
transferring, with a power transfer assembly, the independently identifiable battery from the power source station to the power exchange device based at least in part on the state of charge of the independently identifiable battery.

12. The method of claim 11, further comprising:
charging, with the power source station, the independently identifiable battery while the independently identifiable battery is positioned within a storage compartment of the power source station.

13. The method of claim 12, further comprising:
supplying electrical power from a powertrain control system electrically coupled with the control unit of the power source station.

14. The method of claim 12, further comprising:
supplying electrical power from a generator electrically coupled with the control unit of the power source station.

15. The method of claim 12, further comprising:
determining, with the computing system, a defined state of charge needed to complete a defined flight plan for the aerial vehicle.

16. The method of claim 15, further comprising:
comparing, with the control unit, the defined state of charge to a current state of charge of the independently identifiable battery.

17. An agricultural system comprising:
an aerial vehicle configured to apply an agricultural product to a defined location within a field;
a base station including a docking station, the base station comprising:
a power source station configured to store independently identifiable batteries; and
a power exchange device configured to install one of the independently identifiable batteries within the aerial vehicle; and
a power transfer device configured to transfer the one of the independently identifiable batteries to the power exchange device.

18. The agricultural system of claim 17, further comprising:
a control unit configured to:
provide power to one or more independently identifiable batteries stored within the power source station.

19. The agricultural system of claim 17, further comprising:
a control unit configured to:
select one of the independently identifiable batteries based at least in part on a state of charge of the independently identifiable batteries.

20. The agricultural system of claim 17, further comprising:
an identification system including one or more sensing devices configured to identify each of the independently identifiable batteries within the power source station.
